(19) United States
(12) Patent Application Publication
(10) Pub. No.: US 2017/0374394 A1
(43) Pub. Date: Dec. 28, 2017

(54) METHOD AND APPARATUS FOR PROVISION OF ENHANCED MULTIMEDIA CONTENT

(71) Applicant: THOMSON LICENSING, Issy les Moulineaux (FR)

(72) Inventors: Mark TURNER, Altadena, CA (US); Josh LIMOR, Sherman Oaks, CA (US)

(21) Appl. No.: 15/541,664

(22) PCT Filed: Dec. 29, 2015
(86) PCT No.: PCT/US2015/067911

§ 371 Date: Jul. 5, 2017

Related U.S. Application Data
(60) Provisional application No. 62/099,919, filed on Jan. 5, 2015.

(51) Int. Cl. H04N 21/2343; G06F 17/30; H04N 9/64; H04N 21/258

(52) U.S. Cl. CPC H04N 21/2343; H04N 21/25833; H04N 21/25825; G06F 17/3082; G06F 17/30858; H04N 9/646

(57) ABSTRACT

Ways to generate, store, and distribute optimized content are described. Content modification operations including color correction are stored as metadata that is embedded in each content item. The metadata is extracted in order to eliminate or update the modification operations. Modification operations are updated based at least partly on profiles associated with one or more content provision elements. The profiles include device profiles and codec profiles. Each profile may be specific to a particular element or be a generic profile associated with multiple elements. The profiles are generated based on evaluation of the devices and codes and are stored as entries in a look up table. When content is provided, the profiles are used to optimize the content for display.

### CROSS-REFERENCE TO RELATED APPLICATIONS

This application is a claims priority to U.S. Provisional Patent Application Ser. No. 62/099,919 filed on Jan. 5, 2015 entitled “Image Processing Concepts Using Metadata”.

### BACKGROUND

Many media resources and/or providers utilize color correction technology (and/or other processing operations) when processing video content and/or providing video content to end users. Typically, once modifications are made, the modifications are embedded into the content item without delineation from the unmodified original content. Thus, information regarding the unmodified content or modifications is lost. Many media resources would prefer to be able to identify and/or undo changes made to content items.

In addition, many providers wish to optimize content for delivery across various available platforms (e.g., playback devices, codecs, etc.). Current solutions do not provide platform-specific optimizations.

Thus, there is a need for ways to retain and store information related to modifications such that the unmodified information can be utilized to provide an optimized end-user experience based on playback device characteristics.

### SUMMARY

Some embodiments may identify various modifications (e.g., color correction, luminance processing, resolution adjustments, etc.) made during processing and/or delivery of media content. Such modifications may be formatted as metadata and embedded into the associated content item. In this way, modifications to a content item may easily be identified, undone, enhanced, and/or otherwise manipulated based on evaluation of the metadata associated with such a content item. Such videos with embedded metadata may be stored in the same storage location as the original video, in the cloud on a remote server, and/or on a separate storage device.

Using such embedded metadata, modifications may be made anywhere along the workflow from capture to the point of delivery to an end display device. For example, from the point of original capture, there may be a first pass of color correction followed by subsequent passes of color correction. The modified content may be provided to a delivery provider such as an over-the-top (OTT) service, broadcaster, or physical media encoder where the delivery provider performs additional modifications of content. In some embodiments, each pass of color correction and/or other operations and/or modification may be collected and stored. In addition, some embodiments may retain multiple versions of color correction that may be able to be utilized by other resources.

Some embodiments may generate and store profiles relating to the response functions of a variety of display devices and/or other playback resources (e.g., codecs, communication channels, developers, providers, video standards, etc.). General or generic profiles may also be generated relating to generic video display standards, devices, and/or physical media (e.g., digital video discs, Blu-ray discs, etc.). Profiles may be generated utilizing an automated testing and/or certification system or procedure.

Such profiles may be stored in a look-up table (LUT) and/or other appropriate resource. Once the profiles are made available, color correction data may be generated, archived, and/or utilized at any point along the workflow. A delivery provider may determine which end device (and/or device type) is being used to view a video. The delivery provider may then use the embedded metadata to modify the video based on various relevant factors (e.g., device type, codec profile, etc.). In some embodiments, a display device may be able to request content that matches one or more stored profiles.

Embedded metadata of some embodiments may be used to account for error correction techniques that may be used on an end device. For example, an end device may use a technique to “fix” an intentional film grain effect that is wrongly identified as noise. In that case, metadata may be used to reinstate film grain that was eliminated by a delivery provider, codec, end device, etc.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a system that provides multimedia content according to an exemplary embodiment;

FIG. 2 illustrates a schematic block diagram of a system of some embodiments that utilizes embedded metadata for enhanced content delivery;

FIG. 3 illustrates a schematic block diagram of a system of some embodiments that processes content for delivery to a user device;

FIG. 4 illustrates a flow chart of an exemplary process of some embodiments that collects and stores metadata associated with multimedia content items;

FIG. 5 illustrates a flow chart of an exemplary process of some embodiments that generates playback profiles;

FIG. 6 illustrates a flow chart of an exemplary process of some embodiments that retrieves profiles for use during playback;

FIG. 7 illustrates a flow chart of an exemplary process of some embodiments that delivers content to a display device; and

FIG. 8 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to collect and store metadata relating to color correction and/or other media processing operations. In addition, some embodiments utilize profile information to apply image processing that is optimized for particular playback resources.

For simplicity, media or multimedia content may be referred to as “video content” throughout this disclosure. In addition, the specific example of color correction may be used throughout the specification, but such discussion may apply to various types of media modifications.

A first exemplary embodiment provides a method that provides image processing information in metadata associated with media content. The method includes: retrieving a content item; receiving a set of modifications to the content item; generating metadata based at least partly on the set of modifications; and storing the content item including the generated metadata.

A second exemplary embodiment provides a content server that provides image processing information in metadata associated with media content. The content server includes a processor for executing a set of instructions and a non-transitory medium that stores the set of instructions. The set of instructions includes: retrieving a content item; receiving a set of modifications to the content item; generating metadata based at least partly on the set of modifications; and storing the content item including the generated metadata.

A third exemplary embodiment provides a method that provides optimized content to a display device. The method includes: identifying the display device; retrieving a device profile associated with the identified display device; receiving a selection of a content item; and performing image processing operations based at least partly on the device profile.

A fourth exemplary embodiment provides a video processing server that provides optimized content to a display device. The video processing server includes a processor for executing a set of instructions and a non-transitory medium that stores the set of instructions. The set of instructions includes: identifying the display device; retrieving a device profile associated with the identified display device; receiving a selection of a content item; and performing image processing operations based at least partly on the device profile.

A fifth exemplary embodiment provides a method that generates a device display profile. The method includes: retrieving a display device; evaluating the display device; determining a display response function; and storing a display device profile that includes the display response function.

A sixth exemplary embodiment provides a server that generates a device display profile. The server includes a processor for executing a set of instructions and a non-transitory medium that stores the set of instructions. The set of instructions includes: retrieving a display device; evaluating the display device; determining a display response function; and storing a display device profile that includes the display response function.

Several more detailed embodiments are described in the sections below. Section I provides a description of system architectures used by some embodiments. Section II then describes methods of operation of some embodiments. Lastly, Section III describes a computer system which implements some of the embodiments.

### I. System Architecture

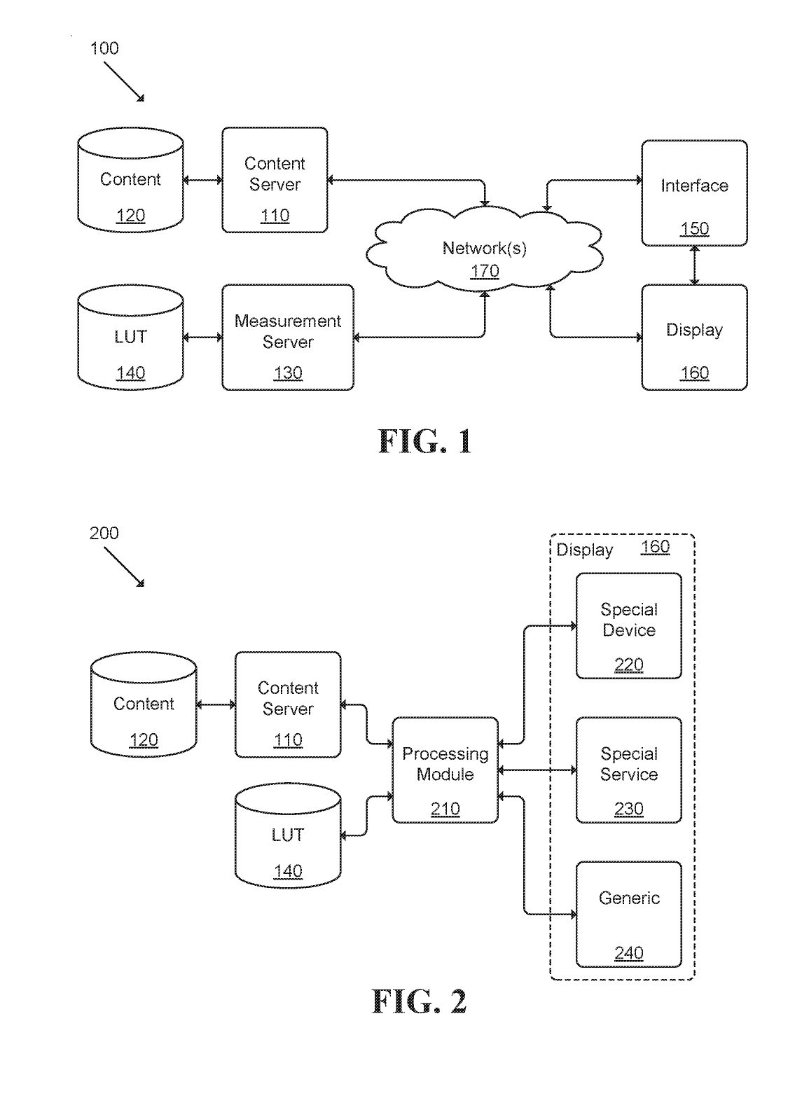

FIG. 1 illustrates a schematic block diagram of a system 100 that provides media content according to an exemplary embodiment. Specifically, this figure shows the communication pathways among the various system elements. As shown, the system may include one or more content servers 110, one or more content storages 120, one or more servers 130, one or more LUT storages 140, one or more interfaces 150, one or more displays 160, and one or more networks 170.

The content server 110 may be an electronic computing device capable of executing instructions and/or manipulating data. The content server may be able to communicate across one or more networks 170 and/or interact with local devices such as content storage 120. The content server 110 may be able to retrieve and provide content items based upon requests received from various users via different types of interface or display devices.

Content storage 120 may be an electronic device that is able to store data including content items and/or provide the data to other system components. In some embodiments, the content storage may be accessed across one or more networks 170 without requiring use of the content server 110. For instance, the content storage 120 may be accessible using one or more application programming interfaces (APIs) and/or other appropriate resources.

The measurement server 130 may be an electronic computing device capable of collecting and/or providing measurement and/or profile data. The server may be able to communicate across one or more networks 170 and/or interact with local devices such as LUT storage 140. The server 130 may be able to collect measurement data from various local or distributed resources (e.g., computing devices, measurement devices or systems, etc.). The server may be able to retrieve and provide measurement information based upon requests received via different types of interfaces 150 or display devices 160.

The LUT 140 may be an electronic device that is able to store profile data and/or provide the data to other system components. In some embodiments, the LUT may be accessed across one or more networks 170 without requiring use of the server 130. For instance, the LUT 140 may be accessible using one or more APIs and/or other appropriate resources.

The profile data may include device profiles for various types of display resources. Such profiles may include, for instance, a response function and/or physical capabilities of such display devices. Such display devices may include televisions, tablets, telephones, monitors, etc. A device profile may include the peak luminance, color response curve, luminance response curve, resolution capabilities, frames per second supported, and/or other appropriate information for each resource. Some embodiments may include profiles related to specific devices (e.g., a specific product model or brand, a sub-type of television, etc.), types of devices (e.g., televisions, tablets, etc.), and/or otherwise associated resources (e.g., any device type that includes a light emitting diode (LED) display). Device profiles may be generated by testing display resources using an automated testing and/or certification procedure.

In addition, the profile data may include video provider profiles that distinguish the physical capabilities of various video service providers. Such physical capabilities may include bandwidth, compression, video codecs, methods of video distribution, etc. Video provider profiles may be generated by testing the video service providers using an automated testing and/or certification procedure.

The profile data may further include codec profiles for use by various display resources and/or multimedia applications executed by such resources. Codec profiles may include types of video codecs that may be utilized on each display device. Codec profiles may also include different video codecs that may be applied to certain video standards. For example, an H.265 video codec developed by the manufacturer of a certain tablet may produce different results than an H.265 video codec developed by a streaming application for use on the same tablet.

Some embodiments include physical media profiles that distinguishes the various ways that video content is encoded across different media, such as DVD, Blu-Ray, etc. Physical media profiles may also include information relating to the various ways that video content is encoded by different studios and/or video providers, for different media encoders, or for different versions of the same content.

In addition, the profile data may include general profiles that include resolution and/or video display standards. General profiles may be used by generic display manufacturers (i.e., where specific model profiles are not available) as it may be difficult to account for all possible physical variations between generic devices and/or corresponding video codecs.

Interface 150 may include various elements that are able to receive content and deliver the content to an appropriate display. Such interface elements may include set top boxes, game consoles, media players, app-based media services, personal computers, etc. In addition, the interface may include various software resources such as web plug-ins that may allow playback of media content within other applications (e.g., a web browser).

Display 160 may be a device capable of providing content to one or more users. The display may be a television, monitor, handheld device, etc. In some cases, the display may include one or more interfaces 150.

Network 170 may include various wired networks, wireless networks (e.g., WiFi networks, cellular networks, etc.), macro-networks (e.g., the Internet), and/or other multi-device communication pathways (e.g., Bluetooth link, tether, etc.).

During operation, a technician or other appropriate user may utilize various appropriate resources to modify a content item (e.g., by using a video processing station to apply color correction). The modifications and content item may be received by an element such as content server 110. The content server may embed the modifications as metadata into the content item. Alternatively, the external resource may provide content that already includes embedded metadata.

An end user may select a content item for playback via display 160. The display and/or interface 150 may send a request to the content server 110 and/or storage 120. The content server 110 may request profile information from the server 130 and/or LUT 140, if available. The content server 110 may utilize the profile information to select a particular version of the requested content item and/or to modify the content item based on the profile information. In some cases, the profile information may be sent to the display 160 such that the display applies any modifications to the supplied content.

In addition, a system such as system 100 may be utilized to generate profiles. For instance, server 130 may receive information related to a device or other resource and utilize the information to generate a profile entry in the LUT 140. In some cases, the server may generate the information used to create the profile. For instance, the server may be connected to various test devices that may measure device performance.

While system 100 has been described by reference to various exemplary details, one of ordinary skill in the art will recognize that the device may be implemented in various other ways without departing from the scope of the disclosure. For instance, some embodiments may include additional elements or omit some elements. For instance, some embodiments may include additional elements or omit some elements. As another example, the elements may be arranged in different specific ways with different communication pathways.

FIG. 2 illustrates a schematic block diagram of a system 200 of some embodiments that utilizes embedded metadata for enhanced content delivery. As shown, the system may include content server 110, content storage 120, LUT 140, and display 160 described above. The system 200 may further include a processing module 210, and one or more special devices 220, special services 230, and/or generics 240.

Processing module 210 may be a computing device that is able to interact with content server 110, LUT 140, display 160, and/or other system elements. The processing module 210 may be able to apply various processing operations based on metadata embedded into content items and/or use of profiles. In some embodiments, the processing module 210 may be sub-element of content server 110.

Special device 220 may be associated with a device-specific profile that includes color correction information based on evaluation of the device. Special service 230 may be associated with a provider-specific profile that includes information based on preferences or attributes of a content provider. Generic 240 may be associated with a generic profile that includes information based on attributes associated with a category of devices.

During operation, various users may request content using various devices 220-240. The processing module 210 may evaluate requests for content and identify a device. The processing module may then request, from the LUT 140, a profile associated with the device. Next, the processing module 210 may retrieve the selected content from server 110. Depending on the device characteristics, content, and/or profile information, the processing module 210 may apply various operations to the content (e.g., color correction) before supplying the content to the display 160. Alternatively, profile information may be provided to the display and/or other intermediary delivery element such that modifications may be applied at the display.

In this example, the various elements may be associated with a single provider or other resource. For example, a content provider and/or device manufacturer may provide content that is optimized for a particular display or delivery path. The delivery path may include, for example, OTT services, broadcast, multichannel video programming distribution (MVPD), physical media, etc. Specific devices may then be able to receive content that has been optimized by a particular resource or provider.

While system 200 has been described by reference to various exemplary details, one of ordinary skill in the art will recognize that the device may be implemented in various other ways without departing from the scope of the disclosure. For instance, some embodiments may include additional elements or omit some elements. As another example, the elements may be arranged in different specific ways with different communication pathways.

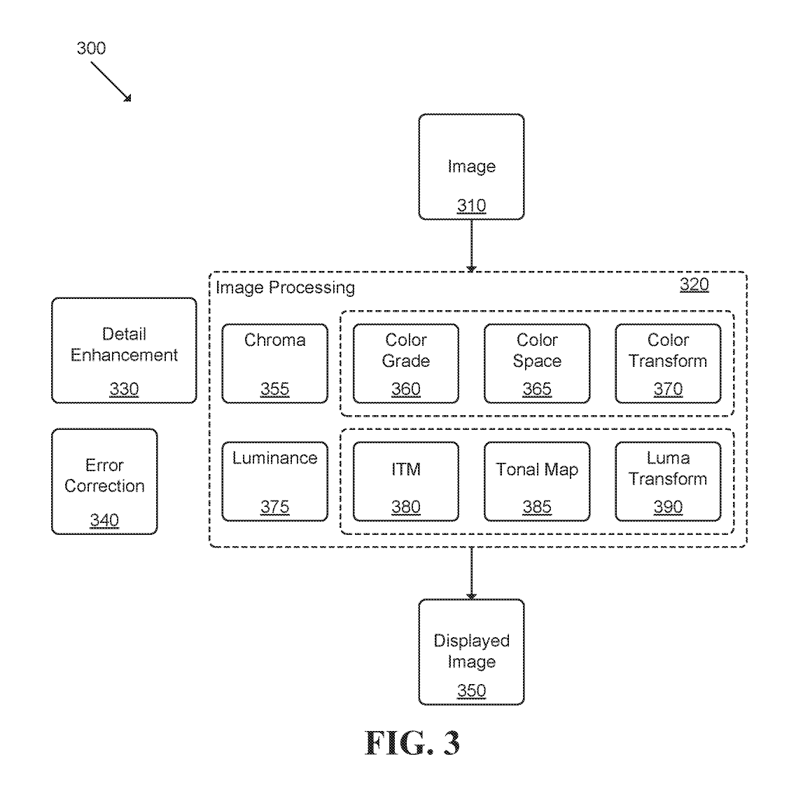

FIG. 3 illustrates a schematic block diagram of a system 300 of some embodiments that processes content for delivery to a user device. Specifically, this figures shows aspects and elements of metadata usage. The system may include an input image 310, an image processing module 320, a detail enhancement module 330, an error correction module 340, and a displayed image 350. As shown, the image processing module 320 may include chroma processing 355, color grading 360, color space processing 365, color transformation 370, luminance processing 375, intelligent tone management (ITM) 380, tonal map 385, and luma transformation 390.

Image 310 may be a digital image, video, and/or other appropriate multimedia content item. Such an image may be provided by a resource such as content server 110.

Image processing module 320 may include various processing sub-modules 355-390. Such sub-modules may be at least partly defined and/or enabled using metadata. Each module may be able to receive, analyze, process, enhance, and/or modify data relating to image 310 and/or image 350. Each module may be able to provide data and/or instructions that are able to be used by other system components to perform various processing operations.

Chroma module 355 may be associated with color purity and/or intensity. Color grade module 360 may be associated with color grade characteristics. Color space module 365 may be associated with characteristics of color space and/or color models. Color transformation module 370 may translate color characteristics for use with a target format and/or end device. Luminance module 375 may be associated with brightness. Tonal map module 385 may be associated with contrast. Luma transform module 390 may be associated with chrominance.

Detail enhancement module 330 may be a computing module for video modification and/or enhancement that may be able to adjust sharpness, contrast, brightness, and/or tone of the image. Error correction module 340 may be a computing module that may be able to reduce noise, remove distortion, etc. In some embodiments, such detail enhancement and/or error correction may be provided independently of any included metadata.

Displayed image 350 may be a digital image or video generated by applying the various modules 320-390 to the input image 310.

During operation, image processing module 320 may receive image 310. The image may then be modified and/or enhanced by chroma module 355, color grade module 360, color space module 365, color transformation module 370, luminance module 375, ITM module 380, tonal map module 385, and/or luma transform module 390. Image 310 may be further modified and/or enhanced by detail enhancement module 330 and/or error correction module 340. The result of such processing may be displayed image 350. Such processing may be at least partly performed, defined, and/or otherwise enabled using metadata embedded in an image.

While system 300 has been described by reference to various exemplary details, one of ordinary skill in the art will recognize that the system may be implemented in various other ways without departing from the scope of the disclosure. For instance, some embodiments may include additional elements or omit some elements. As another example, the elements may be arranged in different specific ways with different communication pathways. Further, single elements could be divided, multiple, and/or multiple elements could be combined into one.

### II. Methods of Operation

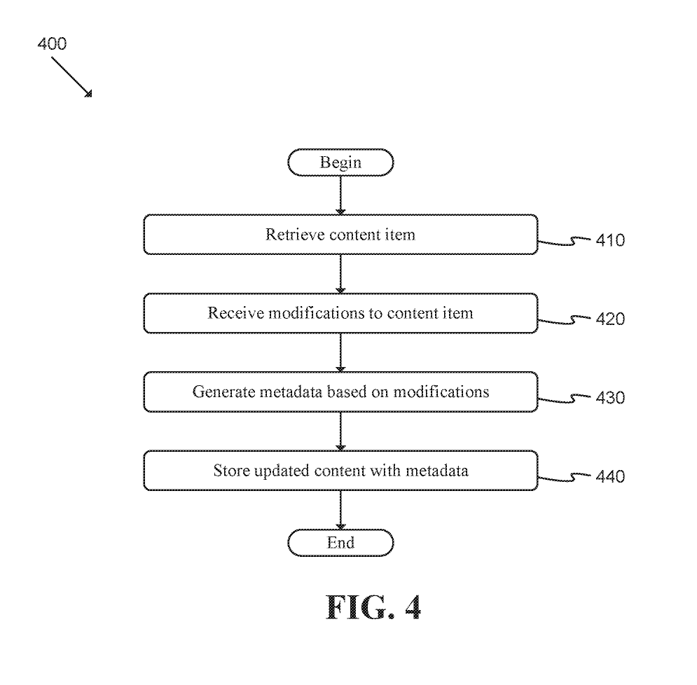

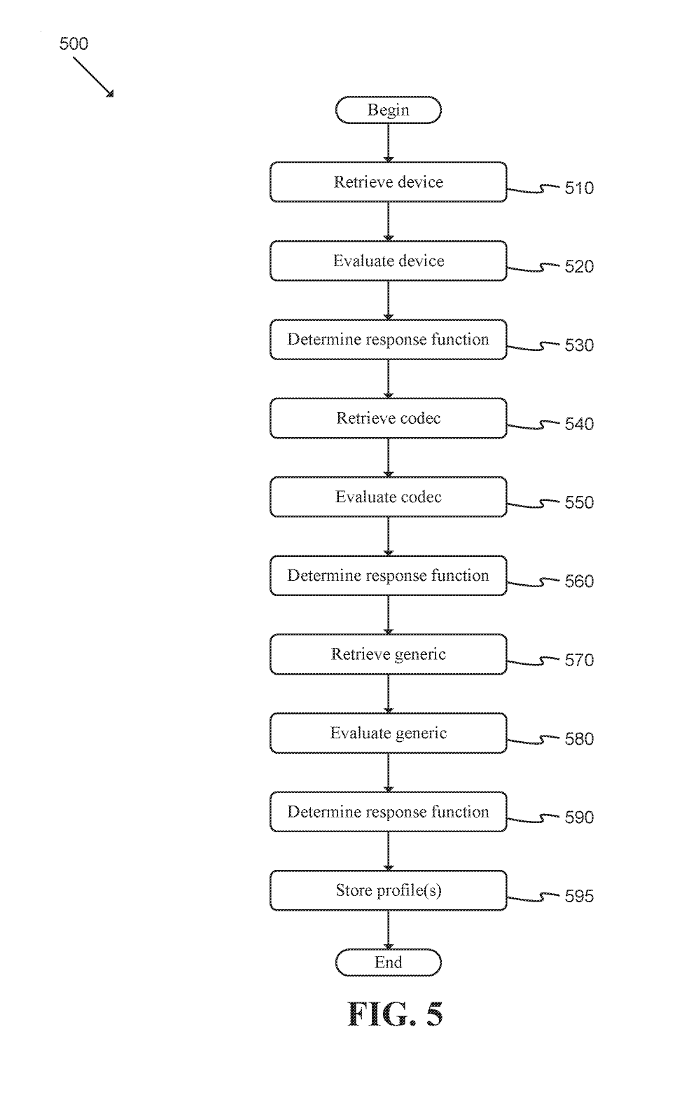

FIG. 4 illustrates a flow chart of an exemplary process 400 of some embodiments that collects and stores metadata associated with content items. Process 400 may be performed by a device such as content server 110 described above. Such a process may be at least partly performed using a resource such as a video processing station that includes one or more computing devices, playback devices, etc. that allow a user to modify media content. The process may begin, for instance, when a technician retrieves a content item for processing.

As shown, the process may retrieve (at 410) a content item. The content item may be retrieved from, for example, devices such as content server 110 and/or content storage 120. Such a content item may be a media file including video, audio, etc.

Next, the process may receive (at 420) modifications to the content item. The modifications may be performed by a technician using a type of video system. Alternatively, modifications may be performed automatically by a color correction system and/or process.

Modifications may include reverting color corrected material back to a previous state, fixing and/or replacing previously made color correction decisions, and/or modifying and/or enhancing video content.

The process may then generate (at 430) metadata based on the received modifications to the content item. The metadata may relate to the color, luminance, contrast, chrominance, etc. of the image and may reflect any changes, modifications and/or enhancements thereto. Such metadata may include elements such as those described in reference to system 300 above.

Next, the process may store (at 440) updated content with the generated metadata embedded into the content item. The updated content may be stored at a resource such as storage 120.

FIG. 5 illustrates a flow chart of an exemplary process 500 of some embodiments that generates playback profiles. Process 500 may be performed by a device such as server 130 described above. In addition, various automated test elements may be utilized by some embodiments. The process may begin, for instance, when a device is available for evaluation and profile creation.

As shown, the process may retrieve (at 510) a device. The device may include a display 160 and may be a television, monitor, handheld device, smartphone, tablet, etc. Various device characteristics may be identified, such as the type of device, physical capabilities, manufacturer, etc.

Next, the process may evaluate (at 520) the device. The device may be evaluated by utilizing an automated testing and/or certification procedure.

The process may then determine (at 530) the response function of the device based on the evaluation. The response function may indicate the physical capabilities of the device.

Next, the process may retrieve (at 540) a codec. The codec may be utilized by the display device being evaluated, utilized in connection with associated video standards, and/or utilized in connection with associated developers. The codec may be retrieved from an appropriate resource (e.g., the device under evaluation, a server, etc.).

Process 500 may then evaluate (at 550) the codec. Such evaluation may include, for example, identifying a type of codec, determining various parameters associated with the codec, etc. The process may then determine (at 560) the response function of the codec based on the evaluation.

Next, the process may retrieve (at 570) a generic profile. The generic may relate to various resolution and/or video display standards, generic display products, and/or otherwise associated sets of devices.

The process may then evaluate (at 580) the generic. Such evaluation may utilize an automated testing and/or certification procedure. Next, the process may determine (at 590) the response function of the generic based on the evaluation.

Process 500 may then generate and store (at 595) the profile and then may end. The profile may be stored as an entry in LUT 140. The profile may include information related to the various evaluations, response functions, etc. In addition, the profile may include definitions and/or references that may be used by other system resources (e.g., codec identification, provider characteristics, etc.).

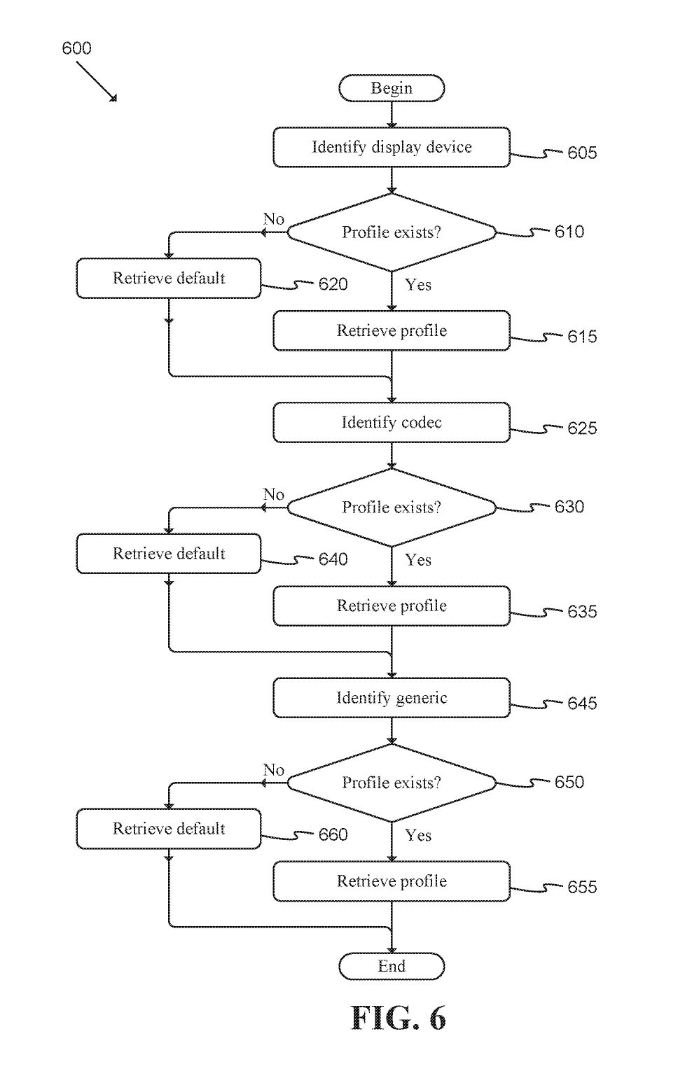

FIG. 6 illustrates a flow chart of an exemplary process 600 of some embodiments that retrieves profiles for use during playback. Process 600 may be performed by a device such as processing module 210 described above. The process may begin, for instance, when a request for content is received.

As shown, the process may identify (at 605) a display device. The display device may be identified in various appropriate ways. For instance, some embodiments may include identifying information in the content request. As another example, the processing module or other resource may request identifying information from the device.

Next, the process may determine (at 610) whether a profile exists for the identified display device. The determination may be based on a search of LUT 140 for the profile.

If the process determines (at 610) that a profile exists for the display device, the process may then retrieve (at 615) the profile. If the process determines (at 610) that a profile does not exist for the display device, the process may then retrieve (at 620) a default profile or generic profile. Both the device profile and the default profile may be retrieved from, for example, devices such as LUT 140.

Next, the process may identify (at 625) a codec. The codec may be identified based on information retrieved from the LUT, based on information in a content request, and/or based on other appropriate criteria.

The process may then determine (at 630) whether a profile exists for the identified codec. The determination may be based on whether the LUT 140 includes a profile for the codec.

If the process determines (at 630) that a profile exists for the codec, the process may then retrieve (at 635) the profile. If the process determines (at 630) that a profile does not exist for the codec, the process may then retrieve (at 640) a default or generic profile. The codec profile and/or the default codec profile may be retrieved from, for example, devices such as LUT 140.

Next, the process may identify (at 645) a generic. The generic may be a type of generic display type, such as a television, monitor, tablet, etc. Alternatively, the generic may be a type of general resolution and/or video format standard, such as 100, 500, or 2000 HDR. The generic may be identified in various appropriate ways (e.g., based on information in a content request, based on communication among devices, etc.).

Process 600 may then determine (at 650) whether a profile exists for the identified generic. The determination may be based on whether the LUT 140 includes such a profile.

If the process determines (at 650) that a profile exists for the generic, the process may then retrieve (at 655) the profile for the generic and then may end. If the process determines (at 650) that a profile does not exist for the generic, the process may then retrieve (at 660) a default profile and then may end. The generic profile and the default generic profile may be retrieved from, for example, devices such as LUT 140.

One of ordinary skill in the art will recognize that various operations of process 600 may be omitted based on relevant criteria. For instance, if a specific device and codec profile exist, the process may skip operations related to generic identification and retrieval. As another example, a display device profile may include a profile of any codec(s) associated with the device. Thus, if the device is able to be identified, operations related to codec and generic identification and retrieval may be omitted. In addition, some operations may be performed multiple times (e.g., a generic device profile and generic codec profile may be identified when no specific profiles are available or appropriate).

After the profile(s) have been identified and retrieved, the profile(s) may be utilized by a delivery process such as process 700 described below. In addition to the specific profiles described above, various other appropriate profiles may be retrieved (and/or associated with or included in the device profile). For instance, some embodiments may utilize profiles associated with content providers, user groups, etc.

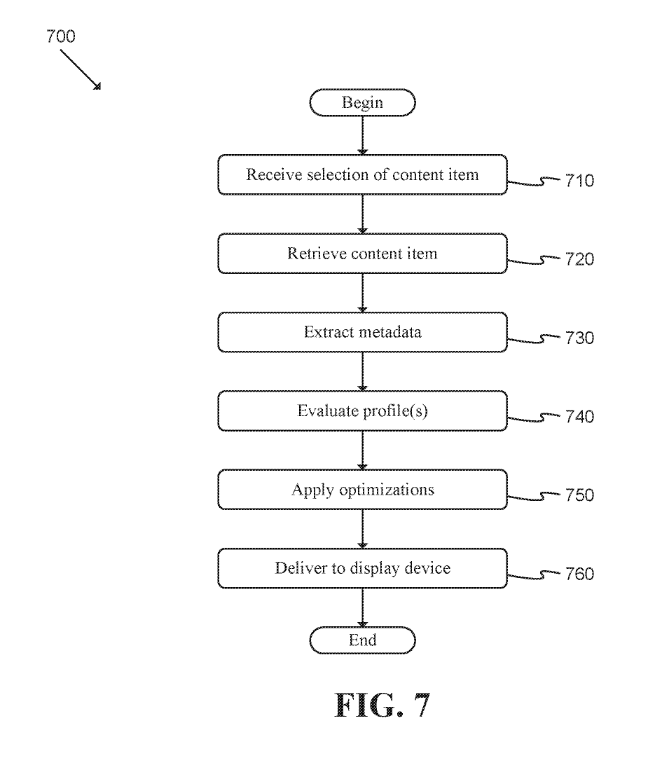

FIG. 7 illustrates a flow chart of an exemplary process 700 of some embodiments that delivers content to a display device. Process 700 could be performed by a device such as processing module 210 described above. The process may begin, for instance, after any appropriate profiles have been identified and retrieved.

As shown, the process may receive (at 710) a selection of content item. The content item selection may be received from, for example, display 160, interface device 150, and/or other appropriate resources. The process may then, retrieve (at 720) the selected content item from an appropriate resource such as content server 110 and/or content storage 120. The content may be in the form of a video or other digital medium.

Next, the process may extract (at 730) metadata from the retrieved content. Such metadata may be generated and associated with the content using a process such as process 400 described above.

Process 700 may then retrieve and evaluate (at 740) the profiles identified by a process such as process 600 described above. Such profiles may be retrieved from a storage such as LUT 140.

The process may then apply (at 750) optimizations. Such optimizations may be based on the profile evaluation, extracted metadata, and/or other appropriate factors (e.g., distribution medium).

Next, the process may deliver (at 760) the optimized content to display device. In some embodiments, the display device may perform such optimization and delivery may include providing the content via interface elements such as a display, speakers, etc.

One of ordinary skill in the art will recognize that processes 400-700 are exemplary in nature and may be implemented in various ways without departing from the scope of the disclosure. For instance, the operations may be performed in different orders, different operations may be included, and/or some operations may be omitted. In addition, the processes (and/or portions thereof) may be performed concurrently, sequentially, iteratively, at regular intervals, and/or based on some specified criteria. Furthermore, each process may be performed as a part of a macro-process and/or be divided into multiple sub-processes.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

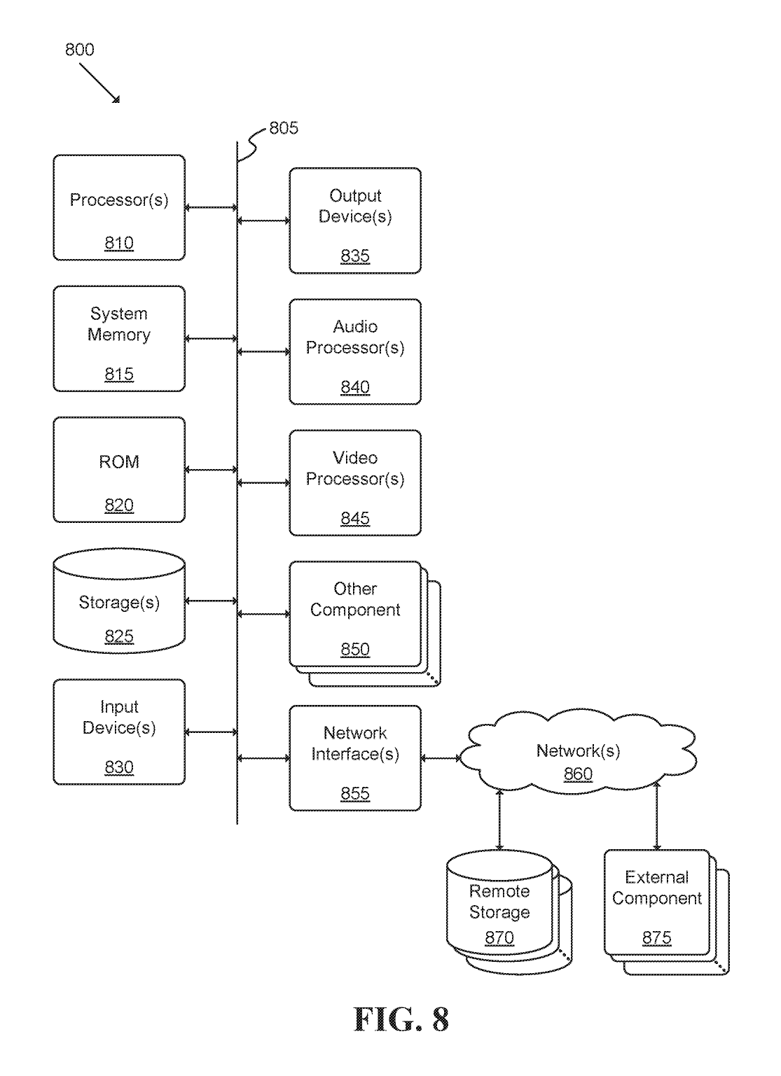

FIG. 8 illustrates a schematic block diagram of an exemplary computer system 800 used to implement some embodiments. For example, the systems described above in reference to FIG. 1-3 may be at least partially implemented using computer system 800. As another example, the processes described in reference to FIGS. 4-7 may be at least partially implemented using sets of instructions that are executed using computer system 800.

Computer system 800 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 800 may include at least one communication bus 805, one or more processors 810, a system memory 815, a read-only memory (ROM) 820, permanent storage devices 825, input devices 830, output devices 835, audio processors 840, video processors 845, various other components 850, and one or more network interfaces 855.

Bus 805 represents all communication pathways among the elements of computer system 800. Such pathways may include wired, wireless, optical, and/or other appropriate communication pathways. For example, input devices 830 and/or output devices 835 may be coupled to the system 800 using a wireless connection protocol or system.

The processor 810 may, in order to execute the processes of some embodiments, retrieve instructions to execute and/or data to process from components such as system memory 815, ROM 820, and permanent storage device 825. Such instructions and data may be passed over bus 805.

System memory 815 may be a volatile read-and-write memory, such as a random access memory (RAM). The system memory may store some of the instructions and data that the processor uses at runtime. The sets of instructions and/or data used to implement some embodiments may be stored in the system memory 815, the permanent storage device 825, and/or the read-only memory 820. ROM 820 may store static data and instructions that may be used by processor 810 and/or other elements of the computer system.

Permanent storage device 825 may be a read-and-write memory device. The permanent storage device may be a non-volatile memory unit that stores instructions and data even when computer system 800 is off or unpowered. Computer system 800 may use a removable storage device and/or a remote storage device as the permanent storage device.

Input devices 830 may enable a user to communicate information to the computer system and/or manipulate various operations of the system. The input devices may include keyboards, cursor control devices, audio input devices and/or video input devices. Output devices 835 may include printers, displays, audio devices, etc. Some or all of the input and/or output devices may be wirelessly or optically connected to the computer system 800.

Audio processor 840 may process and/or generate audio data and/or instructions. The audio processor may be able to receive audio data from an input device 830 such as a microphone. The audio processor 840 may be able to provide audio data to output devices 840 such as a set of speakers. The audio data may include digital information and/or analog signals. The audio processor 840 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 845 (or graphics processing unit) may process and/or generate video data and/or instructions. The video processor may be able to receive video data from an input device 830 such as a camera. The video processor 845 may be able to provide video data to an output device 840 such as a display. The video data may include digital information and/or analog signals. The video processor 845 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 850 may perform various other functions including providing storage, interfacing with external systems or components, etc.

Finally, as shown in FIG. 8, computer system 800 may include one or more network interfaces 855 that are able to connect to one or more networks 860. For example, computer system 800 may be coupled to a web server on the Internet such that a web browser executing on computer system 800 may interact with the web server as a user interacts with an interface that operates in the web browser. Computer system 800 may be able to access one or more remote storages 870 and one or more external components 875 through the network interface 855 and network 860. The network interface(s) 855 may include one or more application programming interfaces (APIs) that may allow the computer system 800 to access remote systems and/or storages and also may allow remote systems and/or storages to access computer system 800 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 800 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that provides image processing information in metadata associated with content, the method comprising:
retrieving a content item;
receiving a set of modifications to the content item;
generating metadata based at least partly on the set of modifications; and
storing the content item including the generated metadata.

2. The method of claim 1, wherein the content item comprises video.

3. The method of claim 1, wherein the set of modifications includes color correction.

4. The method of claim 1, wherein the set of modifications includes at least one of chroma modifications, luminance modifications, color grade modifications, color space modifications, color transform modifications, intelligent tone management modifications, tonal map modifications, and luma transform modifications.

5. A content server that provides image processing information in metadata associated with content, the content server comprising:
a processor for executing a set of instructions; and
a non-transitory medium that stores the set of instructions, wherein the set of instructions comprises:
retrieving a content item;
receiving a set of modifications to the content item;
generating metadata based at least partly on the set of modifications; and
storing the content item including the generated metadata.

6. The content server of claim 5, wherein the content item comprises video.

7. The content server of claim 5, wherein the set of modifications includes color correction.

8. The content server of claim 5, wherein the set of modifications includes at least one of chroma modifications, luminance modifications, color grade modifications, color space modifications, color transform modifications, intelligent tone management modifications, tonal map modifications, and luma transform modifications.

9. A method that provides optimized content to a display device, the method comprising:
identifying the display device;
retrieving a device profile associated with the identified display device;
receiving a selection of a content item; and
performing image processing operations based at least partly on the device profile.

10. The method of claim 9 further comprising:
identifying a codec associated with the display device;
retrieving a codec profile associated with the identified codec; and
performing image processing operations based at least partly on the codec profile.

11. The method of claim 9, wherein the device profile is a generic profile.

12. The method of claim 9, wherein the image processing operations include at least one of chroma processing, luminance processing, color grade processing, color space processing, color transform processing, intelligent tone management processing, tonal map processing, and luma processing.

13. The method of claim 9 further comprising:
extracting metadata from the content item;
identifying a set of image processing modifications included in the extracted metadata; and
performing the image processing operations based at least partly on the set of image processing modifications.

14. A video processing server that provides optimized content to a display device, the video processing server comprising:
a processor for executing a set of instructions; and
a non-transitory medium that stores the set of instructions, wherein the set of instructions comprises:
identifying the display device;
retrieving a device profile associated with the identified display device;
receiving a selection of a content item; and
performing image processing operations based at least partly on the device profile.

15. The video processing server of claim 14, wherein the set of instructions further comprises:
identifying a codec associated with the display device;
retrieving a codec profile associated with the identified codec; and
performing image processing operations based at least partly on the codec profile.

16. The video processing server of claim 14, wherein the device profile is a generic profile.

17. The video processing server of claim 14, wherein the image processing operations include at least one of chroma processing, luminance processing, color grade processing, color space processing, color transform processing, intelligent tone management processing, tonal map processing, and luma processing.

18. The video processing server of claim 14, wherein the set of instructions further comprises:
extracting metadata from the content item;
identifying a set of image processing modifications included in the extracted metadata; and
performing the image processing operations based at least partly on the set of image processing modifications.

19. A method, comprising:
identifying a first device;
evaluating characteristics of the first device;
determining a first response function for the first device based on the evaluation;
storing a profile that includes the first response function for the first device; and
performing image processing on content to be provided to the first device based at least in part on the stored profile.

20. The method of claim 19, wherein the profile is stored as an entry in a look up table.

21. The method of claim 19 further comprising:
identifying a codec associated with the first device;
evaluating characteristics of the codec;
determining a codec response function for the codec based on the evaluation; and
storing a codec profile that includes the codec response function.

22. The method of claim 19, wherein the profile is a generic profile associated with a plurality of devices.

23. A server, comprising:
a processor configured to execute a set of instructions; and
a non-transitory medium configured to store the set of instructions, wherein the set of instructions comprises:
identifying a first device;
evaluating characteristics of the first device;
determining a first response function for the first device based on the evaluation;
storing a profile that includes the determined first response function for the first device; and
performing image processing on content to be provided to the first device based at least in part on the stored profile.

24. The server of claim 23, wherein the profile is stored as an entry in a look up table.

25. The server of claim 23, wherein the set of instructions further comprises:
identifying a codec associated with the first device;
evaluating characteristics of the codec;
determining a codec response function for the codec based on the evaluation; and
storing a codec profile that includes the codec response function.

26. The server of claim 23, wherein the profile is a generic profile associated with a plurality of devices.
